(19) United States
(12) Patent Application Publication
(10) Pub. No.: US 2004/0050358 A1
(43) Pub. Date: Mar. 18, 2004

(54) Magnetically coupled, sealed chamber, toroidal combustion and steam engine

(76) Inventor: Ayton Edward Harrison, West Point, TX (US)

Correspondence Address: AYTON EDWARD HARRISON, 1841 REISS RD,, WEST POINT, TX, 78963, US

(21) Appl. No.: 10/244,483

(22) Filed: Sep. 16, 2002

(51) Int. Cl. F02B 53/00

(52) U.S. Cl. 123/200; 123/241

(57) ABSTRACT

This invention is a hybrid steam & combustion rotary engine designed to use combustion to drive a piston in a continious unidirectional circle within a sealed toroidal chamber. Combustion drives the piston(s) and the heat is utilized to create steam by water injection to induce cooling & extra thrust on the piston(s) within the toroidal chamber(s). Magnetically sensitive pistons are magnetically coupled to a drive axle through the nonmagnetic chamber walls, eleminating the need for combustion seals within the pressure chambers. Tempreature & piston locations are monitored by common tempreature and magnetic sensors located outside the toroidal chambers. The valve opening & closings, as well as ignition, water & fuel injection, are controlled via a common micro-processor. This engine may be used in a steam only modes utilizing exhaust of a conventional combustion engine, to boost power by coupling the piston(s) to the drive shaft of said engine!

### DRAWINGS

This Application Contains 3 Crude Drawings:

FIG. 1 depicts the combustion chamber, which in this case, was a ¾″ copper pipe bent into a circle. The piston in the prototype was a steel ball & is depicted in the drawing as such. The combustion valve is depicted in the uninstalled mode for simplicity.

FIG. 2 depicts 2 magnetic drive wheels attached to the drive axle and a cut away view of the combustion chambers showing their relation to the drive wheel and mode of connecting the combustion chamber to a steam chamber.

FIG. 3 shows a mounting bracket, the drive axle with drive wheels, and combustion chambers mounting on the bracket. The Magnetic wheels must rotate in the circle circumscribed by the inner chamber wall. These drawings were constructed to allow an engineer and a machine shop technician to build a proto-type device and test it within 1 week.

### DESCRIPTION, UTILITY, FIELD AND BACKGROUND OF THIS INVENTION

This invention seeks to improve the energy efficiency, weight to power ratio, cost to manufacture and reliability of the commonly used reciprocal internal combustion engine, by completely replacing it. The typical gasoline engine used to power automobiles is approximately 25% efficient & the Diesel engine is typically less than 40% efficient. The heat generated by these engines becomes a liability for them after an initial combustion forces the piston down the cylinder wall & turns the crankshaft in a single 180-degree stroke. The ensuing 540 degrees of crankshaft rotation is parasitic motion and much of the 180-degree power stroke is leveraged undesirably on the crankshaft. The crankshaft, rods, pistons, cylinder walls, valves & rings must be manufactured of materials that can withstand high pressures and general abuse associated with high-pressure combustions. Methods used to achieve the timing required to produce a 4 cycle internal combustion engine simply require too many parts and increase the expense, weight and failure rate of the engine. Because the reader is assumed to be cognizant of these devices this text will refrain from elaborating on these engines.

This invention confines all significant friction to the combustion chamber & the piston by magnetically coupling the enclosed piston in the combustion chamber to the drive wheel. The magnetic coupling can be varied to effectively nullify the centrifugal force of the piston on the inside of the outside toroidal wall. Further design of the piston will allow the piston to “fly” on an air bearing within the chamber. The drawing for this engine depicts a steel ball as the piston and the toroidal chamber is a ¾″ copper pipe that was “bent” in a circular path, because they were used to construct the prototype. The Magnetic wheel is a 10″ diameter speaker magnet and the combustion valve was made of a solenoid from a junked car. A copper fitting and spring purchased from a hardware store were used to complete the combustion valve & it was soldered in the copper pipe to complete the toroidal chamber. The drive axle is a ½″ steel pipe and an automobile squirrel cage heater fan is used to create forced air induction. This engine can be manufactured in a typical light machine shop for less than $100 of parts bought at retail prices. All monitoring & control functions were done with a standard PC using an assembly language program & the printer port. A very simple microprocessor can control many ganged combustion chambers aligned on a single axle composed of attached magnetic drive wheels.

This invention utilizes most of the heat energy associated with combustion to create propulsion from steam and an efficiency rate of 95% should be obtainable. The use of a closed toroidal chamber eliminates losses and expenses associated with sealing the toroidal chamber with a myriad of seals and physically attaching it to a drive wheel. A variety of easily combustible fuels can be used and all heat generated from combustion becomes a plus factor for the operation of this engine.

This engine benefits from forced air induction and the magnetic drive wheels can be used to supercharge inducted air to be forced into the intake valves of the combustion chambers. Adding blades to the rotating magnetic wheels and enclosing the area between chambers will create an effective supercharger for this engine.

### SUMMARY OF THE INVENTION

This invention is an engine consisting of a magnetic piston sealed inside a continuous toroidal chamber. Common magnetic sensors determine the location of the piston and open a single valve to allow this piston to complete constant unidirectional circular rotations inside the toroidal chamber, the valve serves to create a combustion chamber with the trailing edge of the piston when closed. A magnet is attached to an axle positioned to rotate in the same rotational axis as the piston and serves as a starting device and drive wheel for the magnetic piston. The outer inside wall of the thin walled non-magnetic toroidal chamber is very close to the magnet's rotational path, but never makes physical contact. The piston is magnetically coupled through the toroidal wall to the outside edge of the drive wheel. This engine will benefit from a lengthened combustion chamber attained by increasing the circumference of the toroidal chamber. Centrifugal force is a major contributor to the piston and chamber wall wear, and any lessening of this force by increasing the circular circumference of the piston path will benefit the engine. The use of multiple chambers, each containing a single piston, will create an effective power stroke of more than 360 degrees, as the combustion in the primary chamber is exhausted into other chambers. The piston & magnetic wheel are ideally manufactured from very light weight material and the wall of the combustion chamber must be as thin as possible to maximize control of the piston by the magnetic field. The location of the piston on the outside edge of the magnetic drive wheel's rotational axis tends to maximize the leverage the piston exerts on the drive wheel through the entire axis of rotation. The drive wheel should contain a centrifugally activated counter balance weight to prevent vibration due to the piston's pull on the drive wheel at high rotational speeds (a simple spring that allows the counter weight to move toward the outer edge of the drive wheel as speed increases will accomplish this).

Forced air through the intake valve serves to enhance combustion and can even be used to start this engine. The intake valve will close when the combustion chamber attains a positive inside pressure due to combustion. The ignition device does not extend into the piston's path through the combustion chamber & must depend upon turbulence to ignite the fuel air mixture. Some thought has been given to firing a spark completely across the combustion chamber to a recessed electrode on the opposite side of the chamber.

Copper pipe was used to fabricate the proto-type and the 600-PSI rated pipe showed no sign of rupturing or melting due to temperature or pressure, but no pressure measurements were performed. The wall of copper pipe is, however, too thick to maintain a secure capture of the piston by the rather weak magnet used in the prototype.

Extra Sensors can be added to monitor piston location & velocity to preclude piston valve collision. The combustion valve should remain normally open to prevent a collision due to electrical failure and all other ports for valves, igniters and injectors should be smaller than the piston and chamber cross sectional diameter to minimize the effect on the rotating piston. The intake and exhaust ports should in fact become multiple ports to maximize engine performance. The effective stroke of the piston is obviously increased by pi as the circular diameter (length) of the chamber is increased. This engine, with refinements, will out perform any internal combustion engine known to this inventor. The engine is inexpensive to manufacture, will double and perhaps triple the fuel economy, and with the proper fuel, should produce near zero pollution.

### BACKGROUND OF THIS INVENTION

The concept of this engine comes from the desire to reduce the combustion engine to the simplest mode of operation, with the fewest number of moving and friction producing parts, while reducing the fuel consumption and increasing the efficency of the engine. The concept of a toroidal engine without a compression stroke was an early concept of mine, but the use of seals required to physically attatch the piston to the drive mechanism tended to add weight and friction producing parts to the engine. The idea of completely enclosing a piston in a toroidal chamber, then magnetically coupling the piston to the drive axle led to this invention.

The origional concept of the toroidal chamber used a semi cube rectangler piston formed to the curvature of the chamber to maximize magnetic coupling between the drive axle & the piston, but this proved difficult to fabricate when constructing a prototype. The concept of multiple combustion valves to allow multiple combustions per revolution was also a budget constraint that was discarded in favor of constructing a simple inexpensive proto type engine to test the concept. The portotype used a single combustion valve to create a combustion chamber between the trailing edge of the unidirectional rotating piston, and the combustion valve each time the piston completed a rotation. A copper pipe bent into a circle was used to form the chamber & a steel ball was used as the piston.

Because of the considerable amount of heat generated by combustion I decided the engine required cooling to reduce the temperature & take advantage of the heat. Injecting water into the chamber when the chamber temperature reached 500 degrees F. served to cool the engine and allow several steam powered revolutions for each combustion cycle, thus cooling the chamber & utilizing the beat generated by combustion to drive the piston.

Commonly available magnetic sensors were mounted on the outside chamber wall to sense the piston location within the chamber & open the single combustion valve to allow completion of the piston path through the chamber, then close it to create the combustion or steam chamber. A thermo couple device on the outside chamber wall was used to sense temperature & allow water injection when the tempreature allowed. The printer port of a common PC, using a simple assembly language program, was used for all engine control functions.

Compressed air was used to drive the piston through the chamber to test the timing required to open & close the solinoid used as the combustion valve. A glass marble on a weak spring was installed as the input valve (soldered over the input port, outside of the chamber & piston path) to allow forced air & closure of the intake valve when the chamber pressure reached a pressure equal to, or above, the outside air pressure. The exhaust ports remain open at all times & contain no valving.

### DRAWINGS

This Application Contains 3 Crude Drawings:

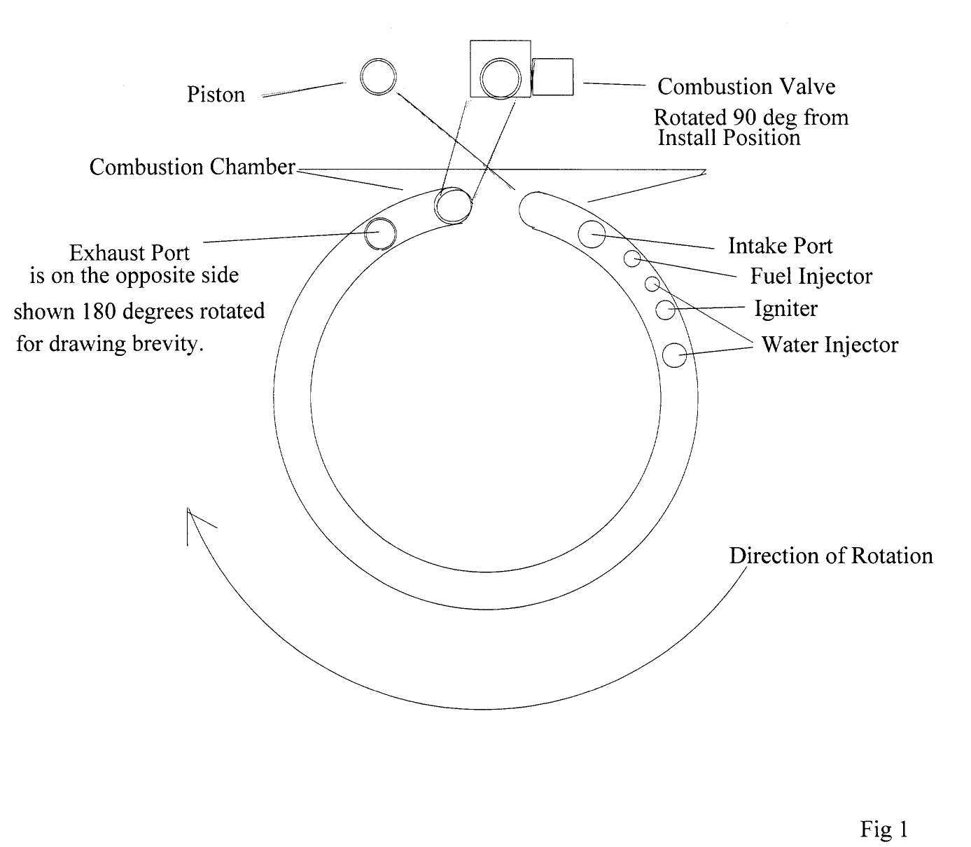

FIG. 1 depicts the combustion chamber, which in this case, was a ¾″ copper pipe bent into a circle. The piston in the prototype was a steel ball & is depicted in the drawing as such. The combustion valve is shown in the uninstalled mode for simplicity.

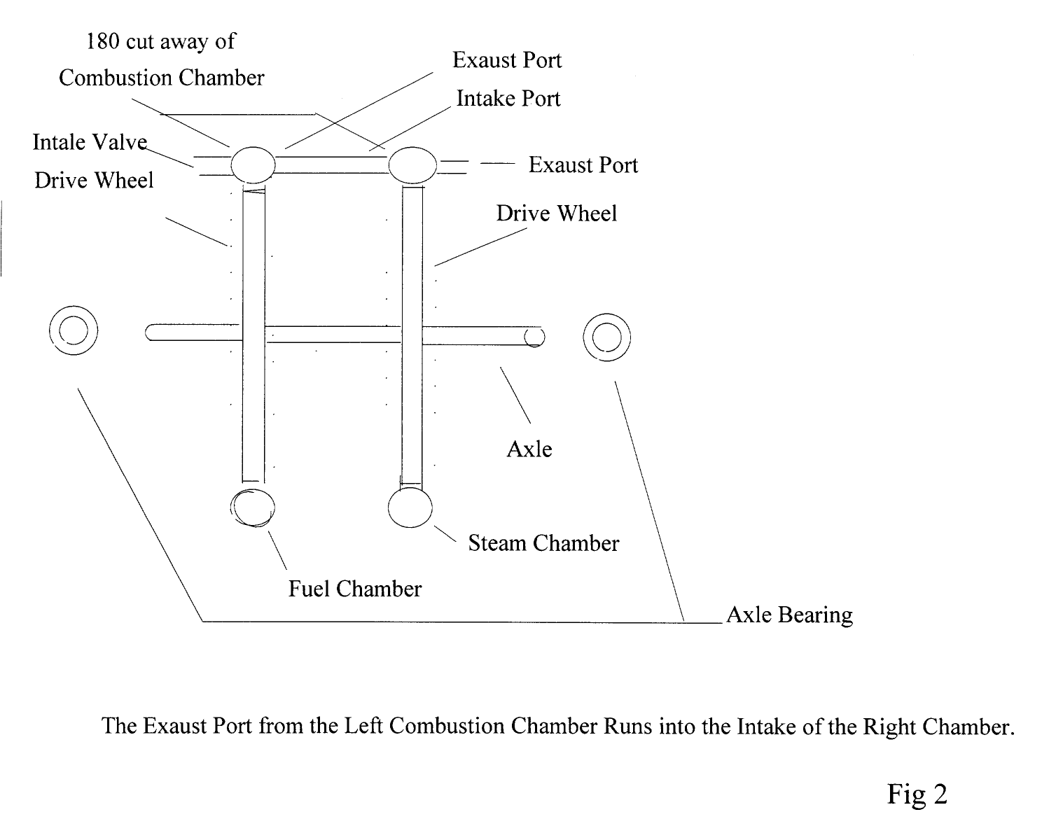

FIG. 2 depicts 2 magnetic drive wheels attached to the drive axle and a cut away view of the combustion chambers showing their relation to the drive wheel and mode of connecting the combustion chamber to a steam chamber.

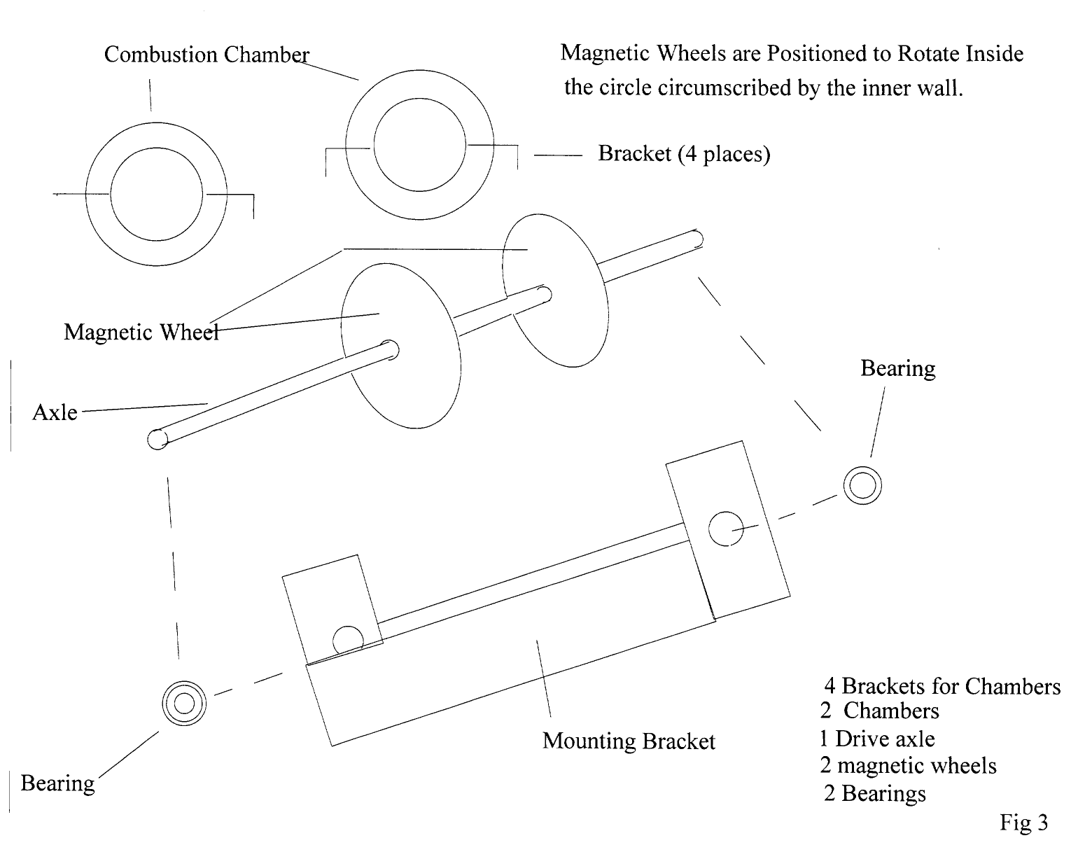

FIG. 3 shows a mounting bracket, the drive axle with drive wheels, and combustion chambers postion's on the bracket. The magnetic wheels must rotate in the circle circumscribed by the inner wall of the toroidal chamber.

These drawings were constructed to allow an engineer and a machine shop technician to build & test a crude prototype within one week!

### UTILITY OF THE INVENTION

This invention seeks to improve the energy efficiency, weight to power ratio, cost to manufacture and reliability of the commonly used reciprocal internal combustion engine, by replacing it. In addition, this invention can utilize the exhaust of a typical internal combustion engine to create a steam powered assist by running the exhaust into the input valve, injecting water & installing magnet couplers on the drive shaft of said engine.

The typical gasoline engine used to power automobiles is approximately 25% efficient & the Diesel engine is typically less than 40% efficient. The heat generated by these engines becomes a liability for them after an initial combustion forces the piston down the cylinder wall & turns the crankshaft in a single 180-degree stroke. The ensuing 540 degrees of crankshaft rotation is parasitic motion and much of the 180-degree power stroke is leveraged undesirably on the crankshaft. The crankshaft, rods, pistons, cylinder walls, valves & rings must be manufactured of materials that can withstand high pressures and general abuse associated with high-pressure combustions. Methods used to achieve the timing required to produce a 4 cycle internal combustion engine simply require too many parts and increase the expense, weight and failure rate of the engine. Because the reader is assumed to be cognizant of these devices this text will refrain from elaborating on these engines.

Mode of Operation:

The cycle starts with the piston near the closed combustion valve & moving away from the combustion valve to create a chamber between the trailing edge of the piston and combustion valve. The piston then passes the intake port where air is drawn or forced into the chamber, then the piston passes the fuel injector where fuel is injected into the chamber. When the air fuel mixture reaches the ignitor it is ignited & combustion occurs. The combustion forces the piston in a unidirectional path toward the constantly open exhaust port and causes the input valve to close due to positive air pressure in the chamber. Exhaust gasses escape from the exhaust port when the piston passes this port The combustion valve opens to allow the piston to complete the circular motion through the chamber and begin another cycle as the piston's leading edge forces any residual gasses out of the exhaust port.

When the Chamber reaches a tempreature of 500 degrees, water is injected instead of fuel to induce cooling & create a steam powered cycle. Any chamber operating in the steam only mode by using the exhaust from another chamber or a conventional internal combustion engine will not need a fuel injector or ignitor. The combustion valve opening & closing, fuel injection, and tempreature are monitored & controlled by a simple micro processor using common magnetic & tempreature sensors to determine piston location, velocity and tempreature of the chamber.

The piston is magnetically coupled to the drive shaft by a magnet attatched to an arm (or wheel) rotating in the same circular plane as the piston, inside the circle circumscribed by the inner wall of the toroidal chamber. Because the piston and valve timing inside the chamber is independent of the magnetic coupler, any under run, or over run of the magnetic coupler will not affect engine operation.

This invention confines all significant friction to the combustion chamber & the piston by magnetically coupling the enclosed piston in the combustion chamber to the drive wheel. The magnetic coupling can be varied to effectively nullify the centrifugal force of the piston on the inside of the outside toroidal wall. Further design of the piston will allow the piston to “fly” on an air bearing within the chamber. The drawing for this engine depicts a steel ball as the piston and the toroidal chamber is a ¾″ copper pipe that was “bent” in a circular path, because they were used to construct the prototype. The Magnetic wheel is a 10″ diameter speaker magnet and the combustion valve was made of a solenoid from a junked car. A copper fitting and spring purchased from a hardware store were used to complete the combustion valve & it was soldered in the copper pipe to complete the toroidal chamber. The drive axle was a steel pipe and a squirrel cage heater fan is used to create forced air induction. The prototype can be manufactured in a light machine shop for less than $100 of parts bought at retail prices. All monitoring & control functions were done with a standard PC using an assembly language program & the printer port. A simple microprocessor can control many combustion chambers aligned on a single axle composed of attached magnetic drive wheels.

### SUMMARY OF THIS INVENTION

This invention is an engine consisting of a magnetic piston sealed inside a continuous toroidal chamber. Common magnetic sensors determine the location of the piston and open a single valve to allow the piston to complete constant unidirectional circular rotations inside the toroidal chamber, the valve serves to create a combustion chamber with the trailing edge of the piston when closed. A magnet is attached to an axle positioned to rotate in the same rotational axis as the piston and serves as a starting device and drive wheel for the magnetic piston. The outer inside wall of the thin walled non-magnetic toroidal chamber is very close to the magnet's rotational path, but never makes physical contact. The piston is magnetically coupled through the toroidal wall to the outside edge of the drive wheel. This engine will benefit from a lengthened combustion chamber attained by increasing the circumference of the toroidal chamber. Centrifugal force is a major entributor to the piston and chamber wall wear, and any lessening of this force by increasing the circular circumference of the piston path will benefit the engine. The use of multiple chambers, each containing a piston, will create an effective power stroke of more than 360 degrees, as the combustion in the primary chamber is exhausted into other chambers. The piston & magnetic wheel are ideally manufactured from very light weight material and the wall of the combustion chamber must be as thin as possible to maximize control of the piston by the magnetic field. The location of the piston on the outside edge of the magnetic drive

What I claim as my invention is:

1. An enclosed Toroidal Chamber of a non magnetic material consisting of a magnetically sensitive, or magnetic piston or pistons inserted during construction, and a single valve that can be opened to allow the piston(s) to complete a rotation around the central axis of the toroidal chamber, and closed to form a combustion chamber with the trailing edge of the piston.

2. The use of a permanent, or electrical magnet or magnets to effect a drive mechanism that magnetically couples the piston in claim 1 to an orthogonal axle to effect a drive mechanism driven by said piston.
